(19) United States
(12) Patent Application Publication
(10) Pub. No.: US 2026/0008370 A1
(43) Pub. Date: Jan. 8, 2026

(54) METHOD FOR PERFORMING AN AUTOMATED CHARGING AND/OR DISCHARGING PROCESS OF A BATTERY OF A MOTOR VEHICLE

(71) Applicant: Robert Bosch GmbH, Stuttgart (DE)

(72) Inventors: Stefan Nordbruch, Leonberg (DE); Vera Schumacher, Gerlingen (DE); Jan Leininger, Ludwigsburg (DE)

(21) Appl. No.: 19/234,414

(22) Filed: Jun. 11, 2025

(30) Foreign Application Priority Data
Jul. 4, 2024 (DE) 10 2024 206 303.7

(51) Int. Cl. B60L 53/36; B60L 53/60; B60W 30/06

(52) U.S. Cl. CPC B60L 53/36; B60L 53/60; B60W 30/06; B60W 2510/1005; B60W 2520/04

(57) ABSTRACT

A method provided for performing an automated charging and/or discharging process of a battery of an at least highly automated motor vehicle. The method includes: receiving, by a main system, a request for performing an automated charging and/or discharging process of the battery; starting an AVP system by the main system to guide the motor vehicle to a charging location; guiding the motor vehicle by the AVP system to the charging location in such a way that the motor vehicle drives to the charging location, parks there, and assumes a safe handover state; after the motor vehicle has parked and assumed the handover state at the charging location; informing an AVC system that the AVP process has ended; charging and/or discharging the battery of the motor vehicle parked at the charging location, according to the request, by the AVC system as part of an AVC process.

### CROSS REFERENCE

The present application claims the benefit under 35 U.S.C. § 119 of German Patent Application No. DE 102024 206 303.7 filed on July 4, 2024, which is expressly incorporated herein by reference in its entirety.

### FIELD

The present invention relates to a method and a system for performing an automated charging and/or discharging process of a battery of an at least highly automated motor vehicle, to a computer program and to a machine-readable storage medium.

### BACKGROUND INFORMATION

U.S. Patent Application Publication No. US 2022/055495 A1 describes a charging system for a vehicle.

Japan Patent Application No. JP 2020-072625 A describes a charging device.

China Utility Model Specification No. CN 208930235 U describes a charging robot.

China Utility Model Specification No. CN 218138153 U describes a charging system for a vehicle.

Germany Patent Application No. DE 102018003467 A1 describes a method for autonomous parking and electrical charging of an energy store of a motor vehicle.

China Patent Application CN 106183843 A describes a stationary electric vehicle charging station.

China Utility Model Specification CN 208930235 U describes an automated parking of a vehicle as well as a charging station for automatically performing a charging process.

U.S. Patent Application Publication No. US 2022/0055495 A1 describes an automated parking of a vehicle as well as a charging station for automatically performing a charging process.

PCT Patent Application No. WO 2022/040556 A1 describes a method for automatically charging an electrical energy store of a vehicle in a charging station with charging parking bays by means of an automated charging unit.

### SUMMARY

An object of the present invention is to provide a concept for performing an automated charging and/or discharging process of a battery of an at least highly automated motor vehicle.

This object may be achieved by means of certain features disclosed herein. Advantageous embodiments of the present invention are disclosed herein.

According to a first aspect of the present invention, a method for performing an automated charging and/or discharging process of a battery of an at least highly automated motor vehicle is provided. According to an example embodiment of the present invention, the method comprises the following steps: receiving, by a main system, a request for performing an automated charging and/or discharging process of a battery of an at least highly automated motor vehicle, starting an AVP system by the main system in order to guide the motor vehicle by the AVP system to a charging location as part of an AVP process, guiding the motor vehicle by the AVP system to the charging location as part of an AVP process in such a way that the motor vehicle drives to the charging location, parks there, and assumes a safe handover state, after the motor vehicle has parked and assumed the handover state at the charging location, informing an AVC system by the AVP system that the AVP process has ended, charging and/or discharging the battery of the motor vehicle parked at the charging location, according to the request, by the AVC system as part of an AVC process.

According to a second aspect of the present invention, a system is provided for performing an automated charging and/or discharging process of a battery of an at least highly automated motor vehicle. According to an example embodiment of the present invention, the system comprises: a main system, an AVP system and an AVC system, wherein the system is configured to perform all steps of the method according to the first aspect of the present invention.

According to a third aspect of the present invention, a computer program is provided, comprising commands that, when the computer program is executed by a computer, for example by the system according to the second aspect of the present invention, cause said computer to perform a method according to the first aspect of the present invention.

According to a fourth aspect of the present invention, a machine-readable storage medium is provided, on which the computer program according to the third aspect of the present invention is stored.

The present invention is based on and includes the finding that the above object may be achieved in that an instance independent of the AVP system and of the AVC system, in the present case the main system, receives a request to perform an automated charging and/or discharging process of a battery of an at least highly automated motor vehicle. According to the request, the main system initiates and/or starts the AVP system so that the AVP system begins an AVP process in order to guide the motor vehicle to the charging location. There, the motor vehicle assumes a safe handover state. Only then does the AVC process by the AVC system start. By providing the main system, the AVP system and the AVC system are thus relieved of receiving the request to perform the automated charging and/or discharging process and therefore do not have to perform this themselves. The AVC system and the AVP system can thus concentrate on their core task, the AVC process and the AVP process, and accordingly only need to be designed for this purpose. This means that these two systems can be implemented in a more simple and less complex manner than if they had to perform further tasks in addition to their actual core task.

By dividing the individual components of the system into three systems, the main system, the AVP system, and the AVC system, these systems can be easily maintained and operated independently of one another.

Furthermore, this in particular results in the technical advantage that the two processes, i.e., the AVP process and the AVC process, are decoupled from one another.

In particular, the motor vehicle being brought into the safe handover state by the AVP system before the AVC process begins results in the technical advantage that the transfer of responsibility for the motor vehicle can be safely transferred from the AVP system to the AVC system. Furthermore, this results in the technical advantage that both systems do not want to and/or are not able to access the motor vehicle at the same time.

At any given time, it is thus clear what is responsible: either the AVP system or the AVC system or even the main system.

Furthermore, this results in the technical advantage, for example, that the AVP system and the AVC system can be implemented independently of each other. In particular, this results in the technical advantage that the AVP system and the AVC system can each be operated by different operators. In particular, this results in the technical advantage that access by the AVP system and by the AVC system can be efficiently controlled and/or regulated. The AVC system only being started when the AVP system has sent a corresponding message about the end of the AVP process to the AVC system thus results in the technical advantage, for example, that the AVC system can only access the motor vehicle for charging and discharging purposes when the AVP process has ended. As long as the AVP process is still being performed, the AVC system does not yet access the motor vehicle.

In particular, this results in the technical advantage that a concept for efficiently performing an automated charging and/or discharging process of a battery of an at least highly automated motor vehicle is provided.

According to an example embodiment of the present invention, starting a system, in particular the AVP system and/or the AVC system, in particular comprises logging into the system, for example by means of a user interface (UI), for example by means of an app, in particular a smartphone app. After log-in, the corresponding process, in particular the AVP process and/or the AVC process, is then begun or started.

A motor vehicle in the sense of the description herein is, for example, an electric motor vehicle or, for example, a hybrid motor vehicle.

A battery in the sense of the description herein is, for example, a drive battery. A drive battery is a battery that is primarily intended to supply electrical energy to the electric motor that provides propulsion for an electric motor vehicle or hybrid motor vehicle. The drive battery can also be referred to as a high-voltage battery, a traction battery, or a deep-cycle battery.

AVP stands for “automated valet parking.” AVC stands for “automated valet charging.”

According to one example embodiment of the method according to the first aspect of the present invention, it is provided that the AVC process comprises the motor vehicle being brought by the AVC system from the safe handover state into an AVC state, in which the battery can be charged and/or discharged, wherein, after charging and/or discharging of the battery has ended, the motor vehicle is brought by the AVC system from the AVC state into the safe handover state.

This results in the technical advantage, for example, that the motor vehicle is in a safe state after charging and/or discharging of the battery has ended, so that, for example, a transfer of responsibility from the AVC system to the AVP system or to the main system can be performed safely.

In the AVC state, the settings necessary for the charging and/or discharging process are set, for example. Bringing into the AVC state comprises, for example, setting the settings necessary for the charging and/or discharging process.

In one example embodiment of the method according to the first aspect of the present invention, it is provided that, after charging and/or discharging has ended, the AVC system informs the main system or the AVP system that the AVC process has ended.

In particular, this results in the technical advantage that the main system or the AVP system efficiently becomes aware that the AVC process has ended.

In one example embodiment of the method according to the first aspect of the present invention, it is provided that only when the motor vehicle has been brought into the safe handover state does the AVC system inform the main system or the AVP system that the AVC process has ended.

This results in the technical advantage, for example, that the informed system only accesses the motor vehicle again when the motor vehicle is in a safe state.

In one example embodiment of the method according to the first aspect of the present invention, it is provided that it comprises the following: when the AVC system informs the main system that the AVC process has ended, starting the AVP system by the main system in order to guide the motor vehicle by the AVP system as part of an AVP process to a further location different from the charging location, in particular to a parking location or pick-up location, guiding the motor vehicle by the AVP system as part of an AVP process from the charging location to the one further location different from the charging location, in such a way that the motor vehicle drives to the one further location different from the charging location, parks there and, in particular, assumes the safe handover state there.

This results in the technical advantage, for example, that after the AVC process the motor vehicle can be efficiently guided to a further location by the AVP system. The further location is, for example, a parking location or is, for example, a pick-up location, where the motor vehicle can be picked up by a person.

According to this example embodiment, it is thus, in particular, provided that, after the AVC process has ended, the main system starts the AVP system so that the AVP system guides the motor vehicle from the charging location to the further location according to an AVP process and/or as part of an AVP process.

In one example embodiment of the method according to the first aspect of the present invention, it is provided that it comprises the following: when the AVC system informs the AVP system that the AVC process has ended, guiding the motor vehicle by the AVP system as part of an AVP process from the charging location to a further location different from the charging location, in particular to a parking location or a pick-up location, in such a way that the motor vehicle drives from the charging location to the one further location different from the charging location, parks there and, in particular, assumes the safe handover state there.

This results in the technical advantage, for example, that after the AVC process the motor vehicle can be efficiently guided to a further location by the AVP system. The further location is, for example, a parking location or is, for example, a pick-up location, where the motor vehicle can be picked up by a person.

According to this example embodiment, it is thus, in particular, provided that, after the AVC process has ended, the AVC system directly informs the AVP system that the AVC process has ended, so that the AVP system guides the motor vehicle from the charging location to the further location according to an AVP process and/or as part of an AVP process.

The AVC system directly informing the AVP system in particular has the technical advantage that the motor vehicle can be guided to the further location particularly quickly and efficiently according to an AVP process in comparison to the embodiment according to which, after the AVC process has ended, the main system starts the AVP system so that the AVP system guides the motor vehicle from the charging location to the further location according to an AVP process and/or as part of an AVP process.

In contrast, the example embodiment of the present invention according to which, after the AVC process has ended, the main system starts the AVP system so that the AVP system guides the motor vehicle from the charging location to the further location according to an AVP process and/or as part of an AVP process has the specific advantage that the main system has control over when the AVP process is to start.

In one example embodiment of the method according to the first aspect of the present invention, it is provided that the main system sends a monitoring request to the AVP system that the AVP system is to monitor the charging and/or discharging of the battery by the AVC system, wherein the AVP system monitors the charging and/or discharging of the battery according to the monitoring request.

This results in the technical advantage, for example, that the charging and/or discharging of the battery can be efficiently monitored.

For performing the AVP process, the AVP system comprises one or more environmental sensors that are arranged spatially distributed within an infrastructure through which the motor vehicle is guided and/or is to be guided by the AVP system in an at least highly automated manner according to an AVP process. Generally and independently of this embodiment, the infrastructure comprises, for example, a parking area, for example a parking facility or a parking garage.

These environmental sensors are thus, in particular, used to monitor the charging and/or discharging. According to this embodiment, it is thus provided that the responsibility for monitoring lies with the AVP system.

Furthermore, this in particular results in the technical advantage that the AVC system itself does not need to have its own environmental sensors for monitoring. This allows the AVC system to be implemented in a technically simpler and less complex manner.

The charging location is thus located, for example, within the infrastructure, i.e., for example, within the parking area, for example within the parking garage or within the parking facility.

Thus, in particular, an infrastructure is provided, within which the motor vehicle is located for performing the AVP process and for performing the AVC process. As already stated above, this infrastructure is, for example, a parking area, for example a parking garage or a parking facility.

An environmental sensor within the meaning of the description herein is, for example, one of the following environmental sensors: radar sensor, lidar sensor, ultrasonic sensor, image sensor, in particular image sensor of a video camera, magnetic field sensor, and infrared sensor.

Monitoring within the meaning of the description thus, in particular, is performed using one or more environmental sensors that are arranged spatially distributed within the infrastructure. Environmental sensors that monitor the charging and/or discharging can thus detect the charging location and output environmental data based on the detection, which data represent the correspondingly detected environment, i.e. in particular, the charging location and, in particular, a surrounding area of the charging location. These environmental data may, for example, be analyzed, in particular by the AVP system in order, for example, to detect a dangerous situation, i.e. a hazard, in order, for example, to be able to respond to it accordingly. This is explained below by way of example with reference to further embodiments.

In one example embodiment of the method according to the first aspect of the present invention, it is provided that the main system specifies a safety area which comprises a charging robot provided for charging and/or discharging and which is to be monitored by the AVP system during charging and/or discharging, and that the main system informs the AVP system of said safety area, wherein the specified safety area to be monitored is monitored by the AVP system during charging and/or discharging of the battery.

This results in the technical advantage, for example, that safety for the motor vehicle and/or for an environment of the motor vehicle can be efficiently increased. According to this embodiment, it is thus provided that a safety area is specified or defined, which is monitored by the AVP system during charging and/or discharging. Monitoring can thus be performed efficiently. The safety area comprises the charging robot, which is provided for charging and/or discharging.

In one example embodiment of the method according to the first aspect of the present invention, it is provided that the main system receives from the AVC system a planned movement area of the charging robot provided for charging and/or discharging, wherein the main system specifies the safety area based on the planned movement area of the charging robot.

This results in the technical advantage, for example, that the safety area can be specified efficiently. In particular, it is specified, for example, that the safety area corresponds to the planned movement area.

Specifying such a safety area results in the technical advantage, for example, that the charging robot cannot cause any damage outside of its planned movement area, for example that no person will be injured by the charging robot, and for example that no person will be able to tamper with the charging robot. The charging robot itself therefore does not need to safeguard its own movements separately since this is achieved via the monitoring of the safety area.

For example, the safety area is adapted to the type of charging robot. The safety area may, for example, also change dynamically. This means that, for example, the safety area can be dynamically adapted by the main system to a speed mode and/or operation mode of the charging robot. The adaptation can alternatively or additionally be carried out by the AVC system, for example.

In one example embodiment of the method according to the first aspect of the present invention, it is provided that the main system informs the AVP system that, in the event of a hazard detected by the AVP system on the basis of the monitoring, the AVP system is to perform one or more safety actions, wherein, in the event of a hazard detected by the AVP system on the basis of the monitoring, one or more safety actions are performed by the AVP system.

This results in the technical advantage, for example, that it is possible to respond efficiently to a detected hazard.

In one example embodiment of the method according to the first aspect of the present invention, it is provided that the one or more safety actions are in each case an element selected from the following group of safety actions: switching off a charging robot provided for charging and/or discharging, interrupting an electrical connection between the battery and a charging station provided for charging and/or discharging, switching off a charging station provided for charging and/or discharging.

This results in the technical advantage, for example, that particularly suitable safety actions can be provided.

In one example embodiment of the method according to the first aspect of the present invention, it is provided that the main system informs the AVP system that a hazard is a breach of the safety area by a living being and/or by an object.

This results in the technical advantage, for example, that it is possible to respond efficiently to a breach of the safety area by a living being and/or an object.

A breach of the safety area means in particular that the living being and/or the object enters the safety area.

In one example embodiment of the method according to the first aspect of the present invention, it is provided that the safe handover state comprises that a drive motor of the motor vehicle is off and/or that a parking brake of the motor vehicle is activated and/or that a position of an automated or automatic transmission of the motor vehicle is in park, i.e. parking with the transmission being mechanically locked against rolling away.

This results in the technical advantage, for example, that the handover state is a particularly safe state.

Statements made in connection with the method according to the first aspect of the present invention apply analogously to the system according to the second aspect of the present invention, and vice versa.

This means in particular that technical functionalities and technical features of the method according to the first aspect of the present invention result analogously from corresponding technical functionalities and technical features of the system according to the second aspect of the present invention, and vice versa.

The method according to the first aspect of the present invention is performed, for example, by means of the system according to the second aspect of the present invention.

The method according to the first aspect of the present invention is, for example, a computer-implemented method.

The system according to the second aspect of the present invention is, for example, configured programmatically to execute the computer program.

The embodiments and exemplary embodiments described here can be combined with one another in any way, even if not explicitly described.

The present invention is explained in more detail below using preferred exemplary embodiments.

### BRIEF DESCRIPTION OF THE DRAWINGS

FIG. 1 shows a flow chart of an example method according to the first aspect of the present invention.

FIG. 2 shows an example system according to the second aspect of the present invention.

FIG. 3 shows a flow chart of a further example method according to the first aspect of the present invention.

FIG. 4 shows a machine-readable storage medium according to the sixth aspect of the present invention.

FIGS. 5 to 9 each show a block diagram according to an example embodiment of the present invention.

In the following, the same reference signs can be used for identical features.

### DETAILED DESCRIPTION OF EXAMPLE EMBODIMENTS

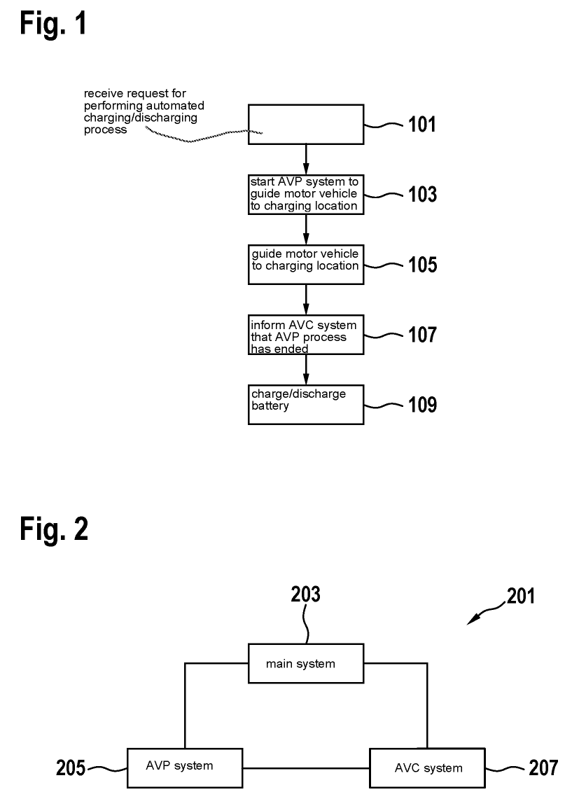

FIG. 1 shows a flow chart of a method for performing an automated charging and/or discharging process of a battery of an at least highly automated motor vehicle, comprising the following steps:

receiving 101, by a main system, a request for performing an automated charging and/or discharging process of a battery of an at least highly automated motor vehicle, starting 103 an AVP system by the main system in order to guide the motor vehicle by the AVP system to a charging location as part of an AVP process, guiding 105 the motor vehicle by the AVP system to the charging location as part of an AVP process in such a way that the motor vehicle drives to the charging location, parks there, and assumes a safe handover state, after the motor vehicle has parked and assumed the handover state at the charging location, informing 107 an AVC system by the AVP system that the AVP process has ended, charging and/or discharging 109 the battery of the motor vehicle parked at the charging location, according to the request, by the AVC system as part of an AVC process.

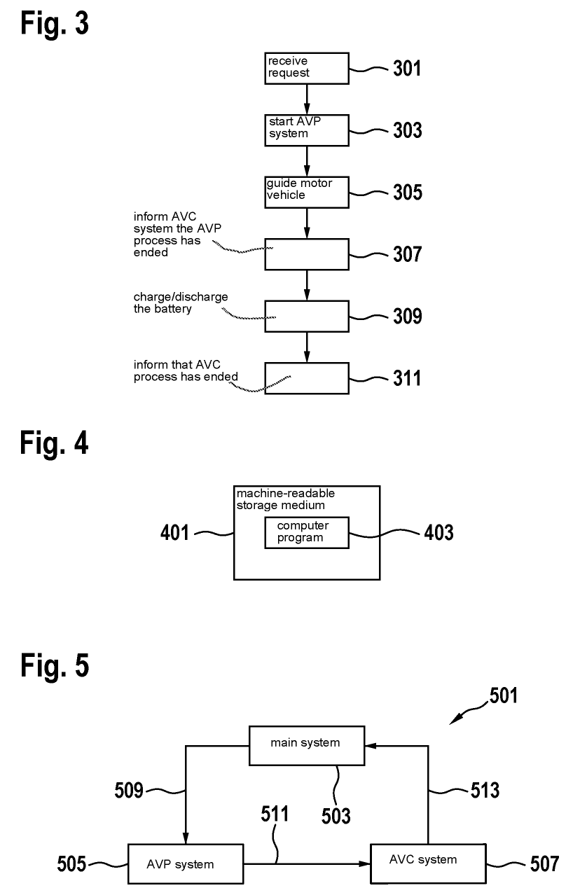

FIG. 2 shows a system 201 for performing an automated charging and/or discharging process of a battery of an at least highly automated motor vehicle, comprising: a main system 203, an AVP system 205 and an AVC system 207, wherein the system 201 is configured to perform all steps of the method according to the first aspect.

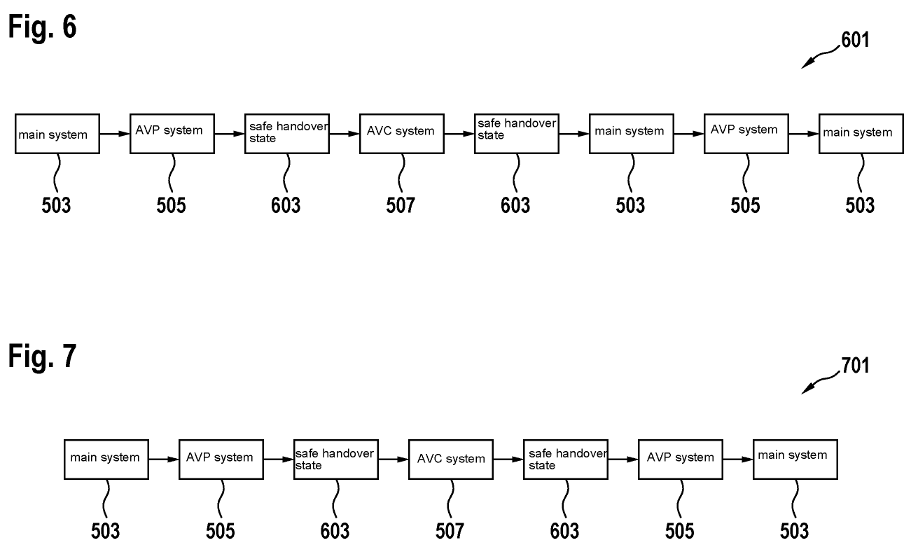

FIG. 3 shows a flow chart of a further method according to the first aspect.

The further method comprises the following steps:

receiving 301, by a main system, a request for performing an automated charging and/or discharging process of a battery of an at least highly automated motor vehicle, starting 303 an AVP system by the main system in order to guide the motor vehicle by the AVP system to a charging location as part of an AVP process, guiding 305 the motor vehicle by the AVP system to the charging location as part of an AVP process in such a way that the motor vehicle drives to the charging location, parks there, and assumes a safe handover state, after the motor vehicle has parked and assumed the handover state at the charging location, informing 307 an AVC system by the AVP system that the AVP process has ended, charging and/or discharging 309 the battery of the motor vehicle parked at the charging location, according to the request, by the AVC system as part of an AVC process, wherein, after charging and/or discharging 309 has ended, the AVC system informs 311 the main system or the AVP system that the AVC process has ended.

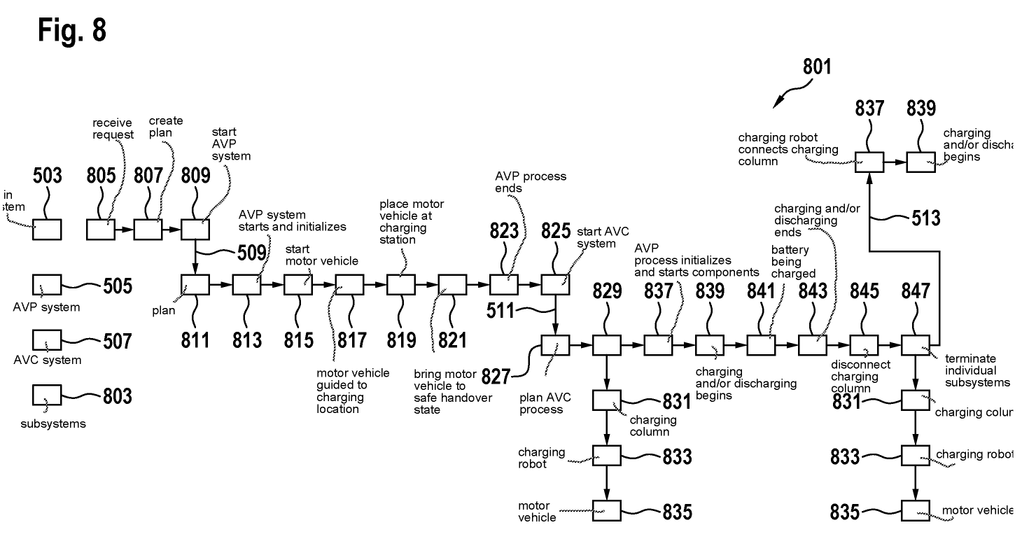

FIG. 4 shows a machine-readable storage medium 401, on which a computer program 403 is stored. The computer program 403 comprises commands that, when the computer program 403 is executed by a computer, for example by the system according to the second aspect, cause said computer to perform a method according to the first aspect.

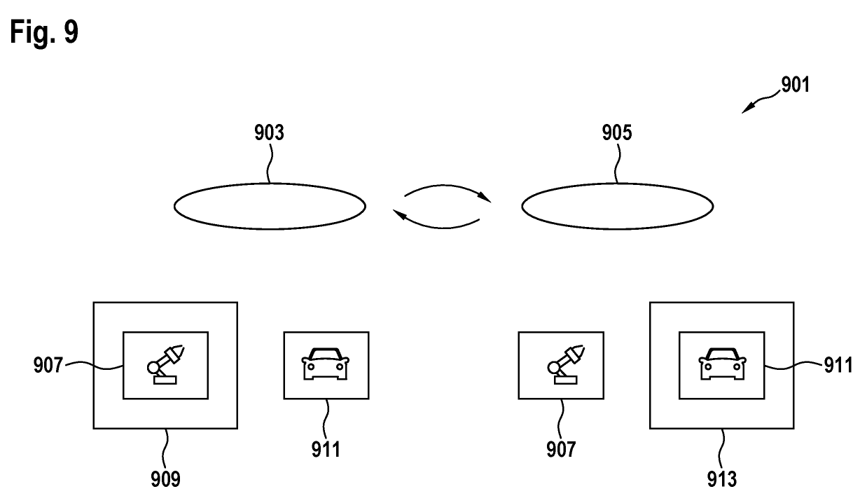

FIG. 5 shows a block diagram 501, which explains the described concept by way of example. According to the concept described here, a main system 503, an AVP system 505 and an AVC system 507 are provided.

The basic idea of this concept is in particular that the processes, i.e. the AVP process and the AVC process, are decoupled so that there is clear responsibility for each phase (AVP or AVC). The main system 503, the AVP system 505 and the AVC system 507 are each implemented separately.

The main system 503 starts the AVP system 505 a request received by the main system 503 for performing an automated charging and/or discharging process of a battery of an at least highly automated motor vehicle and thus transfers responsibility for the AVP process and for the motor vehicle to the AVP system 505. This transfer of responsibility is symbolically indicated by an arrow with reference sign 509.

The AVP system 505 guides the motor vehicle to a charging location as part of an AVP process. As part of the AVP process, the motor vehicle parks at the charging location and assumes a safe handover state.

The safe handover state comprises, for example, that a drive motor of the motor vehicle is off and/or that a parking brake of the motor vehicle is activated and/or that a position of an automated or automatic transmission of the motor vehicle is in park, i.e. a park position with mechanical locking of the transmission against rolling away.

At the end of the AVP process, the motor vehicle is thus in a safe handover state.

The AVP system 505 informs the AVC system 507 that the AVP process has ended, and thus transfers responsibility for the motor vehicle and for the AVC process to the AVC system 507. This transfer of responsibility is symbolically indicated by an arrow with reference sign 511.

The AVC system 507 performs an AVC process according to the request. This means that, as part of an AVC process, the battery of the motor vehicle is charged and/or discharged by the AVC system according to the request.

The AVC process comprises the motor vehicle being brought by the AVC system from the safe handover state into an AVC state, in which the battery can be charged and/or discharged, wherein, after charging and/or discharging of the battery has ended, the motor vehicle is brought by the AVC system from the AVC state into the safe handover state.

This means that the motor vehicle is in a safe handover state after the AVC process.

After the AVC process, it is provided, for example, that responsibility for the motor vehicle is transferred by the AVC system 507 back to the main system 503, which is symbolically indicated by an arrow with reference sign 513.

For example, it may be provided that, after the AVC process has ended, the motor vehicle is to be driven to a further location different from the charging location. Then, for example, the AVC system 507 can transfer responsibility for the motor vehicle to the AVP system 505, which guides the motor vehicle to this further location as part of an AVP process.

For example, it may be provided that, after the AVC process has ended, the motor vehicle is to be driven to a further location different from the charging location. Then, for example, the AVC system 507 can transfer responsibility for the motor vehicle to the system 503, which starts the AVP system 505 and thus transfers responsibility for the motor vehicle and the AVP process to the AVP system 505, which then guides the motor vehicle to this further location as part of an AVP process.

This means that the AVP process is under the responsibility of the AVP System 505. This means that the AVP process is under the responsibility of the AVC system 507.

The main system 503 may, for example, manage or perform booking, planning, billing, etc.

FIG. 6 shows a block diagram 601, which, by way of example, illustrates the statements above. From left to right with respect to the plane of the paper, the individual systems are drawn in the order of their execution in an exemplary embodiment.

The main system 503 transfers responsibility for the AVP process to the AVP system 505. At the end of the AVP process, the motor vehicle is brought into a safe handover state 603. After the AVP process has ended, the responsibility is transferred from the AVP system 505 to the AVC system 507, for performing an AVC process. At the end of the AVC process, the motor vehicle is brought into the safe handover state 603. The AVC system 507 then returns responsibility for the motor vehicle to the main system 503.

As already stated above, it may be provided, for example, that, after the AVC process has ended, the motor vehicle is driven by the AVP system 505 to a further location according to an AVP process.

Correspondingly, the last two blocks are provided to illustrate this graphically. The main system 503 thus transfers responsibility for the AVP process to the AVP system 505, which then guides the motor vehicle to the further location according to an AVP process. After the motor vehicle has arrived at the further location, the AVP system 505 transfers the responsibility back to the main system 503. This last step can be omitted if, for example, the further location is a parking location where the motor vehicle is to be parked and is to stay parked. This step can be omitted, for example, if the further location is a pick-up location where a person picks up the motor vehicle for further use, so that the responsibility then passes to the person.

FIG. 7 shows a further block diagram 701, which, by way of example, illustrates the statements above. From left to right with respect to the plane of the paper, the individual systems are drawn in the order of their execution in an exemplary embodiment. The following statements therefore run from left to right with respect to the plane of the paper.

The main system 503 transfers responsibility for the AVP process to the AVP system 505. At the end of the AVP process, the motor vehicle is brought into a safe handover state 603. After the AVP process has ended, the responsibility is transferred from the AVP system 505 to the AVC system 507, for performing an AVC process. At the end of the AVC process, the motor vehicle is brought into the safe handover state 603.

As already stated above, it may be provided, for example, that, after the AVC process has ended, the motor vehicle is driven by the AVP system 505 to a further location according to an AVP process.

Accordingly, it is provided, for example, that, after the AVC process has ended, the AVC system 505 transfers responsibility for the motor vehicle to the AVP system 505, which guides the motor vehicle to the further location as part of an AVP process. After the AVP process has ended, the AVP system 505 transfers responsibility for the motor vehicle to the main system 503. For example, after this AVP process has ended, the motor vehicle is likewise in a safe handover state, even if this is not shown in the drawing.

FIG. 8 shows a further block diagram 801, which illustrates the described concept by way of example. With regard to the reference signs used in FIG. 8, reference is made to the above statements according to FIGS. 5 to 7. The same reference signs are used.

In addition, reference sign 803 denotes subsystems that can be used as part of the concept described here, which is further described below. These subsystems 803 may, for example, be subsystems of the AVC system 507.

The method starts according to a block 805 at the main system 503, which receives, for example, a request for performing an automated charging and/or discharging process of a battery of an at least highly automated motor vehicle. The execution of the automated charging and/or discharging process is planned according to a block 807 by the main system 503 in order to create a plan for performing the automated charging and/or discharging process. Upon completion of the planning, the main system 503 starts the AVP system 505 according to a block 809. The plan created according to function block 807 for performing the automated charging and/or discharging process is denoted in FIG. 8 by reference sign 811 and is transferred by the main system 503 to the AVP system 505. The latter starts and initializes itself according to a block 813 and performs an AVP process with the motor vehicle based on the planning, i.e. based on the plan 811. This comprises, for example, the AVP system 505 starting the motor vehicle according to a block 815. As part of the AVP process, the motor vehicle is guided to the charging location by the AVP system 505 according to a block 817. According to a block 819, it is provided that the AVP system 505 places the motor vehicle at the charging location, in particular parks it there, as part of the AVP process. According to a block 821, it is provided that the AVP system 505 brings the motor vehicle into a safe handover state. In the safe handover state, for example, the drive motor of the motor vehicle is off and/or, for example, a handbrake of the motor vehicle is activated and/or, for example, a position of an automated or automatic transmission of the motor vehicle is in park.

After block 821, i.e. after the motor vehicle has been brought into the safe state by the AVP system 505, the AVP process has ended according to a block 823, which the AVP system 505 communicates to the AVC system 507. Responsibility for the motor vehicle is transferred to the AVC system 507 according to a block 825. For example, the AVP system 505 starts the AVC system 507 in block 825.

The AVC system 507 independently plans the AVC process according to a block 827. According to a block 829, the AVC system 507 initializes and starts components and/or subsystems necessary to perform the AVC process. Such subsystems include, for example, a charging column 831, a charging robot 833 and the motor vehicle 835. This means that the AVC system 507 prepares the motor vehicle 835 to the point that the battery can be charged and/or discharged. The motor vehicle is thus, in particular, brought into an AVC state. This does not necessarily mean that the drive motor is switched on. This means that, for charging and/or discharging, the motor vehicle 835 does not necessarily have to be ready to drive. For example, it is only put into operation by the AVC system 507 to the point that the battery can be charged and/or discharged.

After starting and initialization according to block 829, it is provided according to a block 837 that the charging robot 833 is used to connect the charging column 831 electrically to the motor vehicle 835. According to a block 839, it is then provided that, for example, charging and/or discharging of the battery begins.

According to a block 841, the battery of the motor vehicle is thus being charged and/or discharged.

In block 843, charging and/or discharging of the battery ends. In block 845, it is provided that the charging column 831 is electrically disconnected from the motor vehicle 835 or from the battery. This is done, for example, using the charging robot 833. The above steps with regard to blocks 837 to 845 are in particular part of an AVC process performed by the AVC system 507. In block 847, which is also comprised by the AVC process, the AVC system terminates the individual subsystems, which means that they are switched off. The charging column 849 is thus switched off. The charging robot 851 is thus switched off. The motor vehicle 853 is thus switched off. For example, the motor vehicle 835 is brought into the safe handover state.

After block 847 has ended, the AVC process has ended, which the AVC system 507 communicates to the main system 503. Accordingly, responsibility for the motor vehicle 835 is transferred from the AVC system 507 to the main system 503. According to a block 837, the main system 503 thus receives a message from the AVC system 507 that the AVC process has ended. Optionally, block 839 may be provided, according to which, according to the above statements, the motor vehicle 835 may be guided by the AVP system 505 to a further location as part of an AVP process. Here, for example, it is again provided that, according to the above statements, responsibility for the AVP process is transferred from the main system 503 to the AVP system 505. The above steps according to blocks 811 to 821 can thus be performed analogously in order to drive the motor vehicle by the AVP system 505 to the further location as part of the AVP process.

FIG. 9 shows a further block diagram 901, which illustrates the described concept by way of example. According to the block diagram 901, an AVC process 903 is provided and an AVP process 905 is provided, which are in each case performed by the AVC system or by the AVP system according to the above statements.

For performing the AVC process, a charging robot 907 is provided, around which a safety area 909 is specified, which is specified, for example, on the basis of the planned movement area of the charging robot 907. The motor vehicle is denoted by reference sign 911 and can be charged by the charging robot 907 as part of the AVC process 903. It is provided, for example, that the AVP system monitors the safety area 909 for breaches.

When transferring the responsibility from one of the systems of the system according to the second aspect to another of the systems of the system according to the second aspect, it is in particular provided that the motor vehicle is in the safe handover state.

During the AVP process, it is provided, for example, that the charging robot 907 is switched off so that it can no longer pose a threat to a surrounding area. For example, around the motor vehicle 911, a further safety area 913 can be specified, which is monitored by the AVP system for breach by an object and/or by a living being, for example a person.

For example, after an AVP or AVC process has ended, the motor vehicle is brought into the safe handover state; for example, the drive motor is switched off. Thus, it is in particular provided that the motor vehicle must be restarted for a further process.

This means, for example, that the AVP process begins with starting the motor vehicle and ends with parking and switching off the motor vehicle.

This means, for example, that the AVC process begins with the switched-off motor vehicle and the starting necessary for the charging process. In particular, starting as part of an AVC process does not necessarily mean that the motor vehicle is ready to drive, but rather that the AVC system puts it into operation from the switched-off state in such a way that the battery can be charged and/or discharged. At the end of the AVC process, the motor vehicle is switched off again so that it can then be restarted by the AVP system if necessary.

According to the concept described here, there is a clear separation of responsibility and, in particular, of access to the motor vehicle by the AVP system and by the AVC system, wherein the respective accesses are separate from one another. This means in particular that access to the motor vehicle always occurs either by the AVP system or by the AVC system but never simultaneously in one phase, i.e. during an AVP process or an AVC process. This means that only the AVP system has access to the motor vehicle as part of the AVP process, and the AVC system and, in particular, the main system do not. This means in particular that only the AVC system has access to the motor vehicle as part of the AVC process, and the AVP system and, in particular, the main system do not.

The concept described here thus comprises, in particular, that the motor vehicle is driven by the AVP system to the charging location where it is to be charged and/or discharged. Here, in particular, it is put into a safe handover state, i.e. for example, brought to a standstill, and it is secured against rolling away, for example. The information that the motor vehicle is at the correct location, i.e. at the charging location, is reported to the AVC system, for example. The charging robot is activated by the AVC system, for example, and the motor vehicle is no longer given permission to move, for example. This means that the motor vehicle is switched from driving mode (AVP mode) to charging and/or discharging mode (AVC mode).

During the AVC process, for example, the environmental sensors of the AVP system monitor an area around the charging robot. This area includes, for example, the entire planned movement area of the robot. If the charging robot moves too close to the edge of this area, the robot will be switched off immediately, for example. If, for example, something from outside, such as a person, moves into the area, the robot will be switched off immediately, for example. The term "robot" here refers to the charging robot.

This advantageously ensures that the charging robot cannot cause any damage outside of its planned movement area, so that, for example, no individual is injured by the robot and so that, for example, no individual can tamper with the robot or the motor vehicle. The charging robot itself does not need to safeguard its movements separately since this is done via the safety area. The size of the safety area is adapted, for example, to the type of charging robot. For example, the size of the safety area can also be dynamically adapted to the speed mode and/or operation mode of the charging robot.

For example, the safety area can be safeguarded by light barriers. This means that the charging robot can be switched off immediately if the light barrier is interrupted from either side. In particular, it is provided that the motor vehicle and the charging robot are both located completely within the safety area. In such a case, it may be provided, for example, that this can be implemented independently of the monitoring by the AVP system.

What is claimed is:

1. A method for performing an automated charging and/or discharging process of a battery of an at least highly automated motor vehicle, the method comprising the following steps:
receiving, by a main system, a request for performing an automated charging and/or discharging process of a battery of an at least highly automated motor vehicle;
starting an automated valet parking (AVP) system by the main system to guide the motor vehicle by the AVP system to a charging location as part of an AVP process;
guiding the motor vehicle by the AVP system to the charging location as part of an AVP process in such a way that the motor vehicle drives to the charging location, parks there, and assumes a safe handover state;
after the motor vehicle has parked and assumed the safe handover state at the charging location, informing an automated valet charging (AVC) system by the AVP system that the AVP process has ended; and
charging and/or discharging the battery of the motor vehicle parked at the charging location, according to the request, by the AVC system as part of an AVC process.

2. The method according to claim 1, wherein the AVC process includes the motor vehicle being brought by the AVC system from the safe handover state into an AVC state, in which the battery can be charged and/or discharged, wherein, after the charging and/or discharging of the battery has ended, the motor vehicle is brought by the AVC system from the AVC state into the safe handover state.

3. The method according to claim 1, wherein, after the charging and/or discharging has ended, the AVC system informs the main system or the AVP system that the AVC process has ended.

4. The method according to claim 2, wherein only when the motor vehicle has been brought into the safe handover state does the AVC system inform the main system or the AVP system that the AVC process has ended.

5. The method according to claim 3, further comprising:when the AVC system informs the main system that the AVC process has ended, starting the AVP system by the main system to guide the motor vehicle by the AVP system as part of an AVP process to a further location different from the charging location, the further location including a parking location or pick-up location; andguiding the motor vehicle by the AVP system as part of an AVP process from the charging location to the further location different from the charging location, in such a way that the motor vehicle drives to the further location different from the charging location, parks there, andassumes the safe handover state there.

6. The method according to claim 3, further comprising:
when the AVC system informs the AVP system that the AVC process has ended, guiding the motor vehicle by the AVP system as part of an AVP process from the charging location to a further location different from the charging location, in particular to a parking location or a pick-up location, in such a way that the motor vehicle drives from the charging location to the one further location different from the charging location, parks there, and assumes the safe handover state there.

7. The method according to claim 1, wherein the main system sends a monitoring request to the AVP system that the AVP system is to monitor the charging and/or discharging of the battery by the AVC system, wherein the AVP system monitors the charging and/or discharging of the battery according to the monitoring request.

8. The method according to claim 7, wherein the main system specifies a safety area which contains a charging robot provided for the charging and/or discharging and which is to be monitored by the AVP system during the charging and/or discharging, and the main system informs the AVP system of the safety area, wherein the specified safety area to be monitored is monitored by the AVP system during the charging and/or discharging of the battery.

9. The method according to claim 8, wherein the main system receives from the AVC system a planned movement area of the charging robot provided for the charging and/or discharging, wherein the safety area is specified by the main system based on the planned movement area of the charging robot.

10. The method according to claim 8, wherein the main system informs the AVP system that, in the event of a hazard detected by the AVP system based on the monitoring, the AVP system is to perform one or more safety actions, wherein, in the event of a hazard detected by the AVP system based on the monitoring, the one or more safety actions are performed by the AVP system.

11. The method according to claim 10, wherein the one or more safety actions are in each case an element selected from the following group of safety actions: (i) switching off a charging robot provided for the charging and/or discharging, (ii) interrupting an electrical connection between the battery and a charging station provided for the charging and/or discharging, (iii) switching off a charging station provided for the charging and/or discharging.

12. The method according to claim 10, wherein the main system informs the AVP system (205, 505) that a hazard is a breach of the safety area by a living being and/or by an object.

13. The method according to claim 1, wherein the safe handover state includes: (i) that a drive motor of the motor vehicle is off and/or (ii) that a parking brake of the motor vehicle is activated and/or (iii) that a position of an automated or automatic transmission of the motor vehicle is in a park position with the transmission being mechanically locked against rolling away.

14. A system for performing an automated charging and/or discharging process of a battery of an at least highly automated motor vehicle, comprising:
a main system;
an automated valet parking (AVP) system; and
an atomated value charging (AVC) system;
wherein the system is configured to:
receiving, by a main system, a request for performing an automated charging and/or discharging process of a battery of an at least highly automated motor vehicle;
start the AVP system by the main system to guide the motor vehicle by the AVP system to a charging location as part of an AVP process;
guiding the motor vehicle by the AVP system to the charging location as part of an AVP process in such a way that the motor vehicle drives to the charging location, parks there, and assumes a safe handover state;
after the motor vehicle has parked and assumed the safe handover state at the charging location, informing the AVC system by the AVP system that the AVP process has ended; and
charging and/or discharging the battery of the motor vehicle parked at the charging location, according to the request, by the AVC system as part of an AVC process.

15. A non-transitory machine-readable storage medium on which is stored a computer program including commands for performing an automated charging and/or discharging process of a battery of an at least highly automated motor vehicle, the commands, when executed by a computer, causing the computer to perform the following steps:
receiving, by a main system, a request for performing an automated charging and/or discharging process of a battery of an at least highly automated motor vehicle;
starting an automated valet parking (AVP) system by the main system to guide the motor vehicle by the AVP system to a charging location as part of an AVP process;
guiding the motor vehicle by the AVP system to the charging location as part of an AVP process in such a way that the motor vehicle drives to the charging location, parks there, and assumes a safe handover state;
after the motor vehicle has parked and assumed the safe handover state at the charging location, informing an automated valet charging (AVC) system by the AVP system that the AVP process has ended; and
charging and/or discharging the battery of the motor vehicle parked at the charging location, according to the request, by the AVC system as part of an AVC process.
